(19) United States
(12) Patent Application Publication
(10) Pub. No.: US 2013/0281596 A1
(43) Pub. Date: Oct. 24, 2013

(54) Compositions Comprising a Propylene-Based Elastomer and a Polyalphaolefin, Methods of Making the Same, and Articles Made Therefrom

(71) Applicants: Rachna Mohan, Chicago, IL (US); Felix M. Zacarias, Akron, OH (US)

(72) Inventors: Rachna Mohan, Chicago, IL (US); Felix M. Zacarias, Akron, OH (US)

(21) Appl. No.: 13/450,057

(22) Filed: Apr. 18, 2012

(51) Int. Cl. C08L 23/16

(52) U.S. Cl. CPC C08L 23/16
USPC 524/427; 525/240; 524/528

(57) ABSTRACT

The present disclosure is directed to compositions comprising: (a) a propylene-based elastomer, comprising at least about 60 wt % propylene-derived units and about 5 to about 25 wt % ethylene-derived units, based on total weight of the propylene-based elastomer, wherein the propylene-based elastomer has a heat of fusion of less than about 80 J/g; and (b) a polyalphaolefin. Such compositions have at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

### FIELD OF THE INVENTION

This invention relates to polymer compositions. More particularly, this invention relates to compositions comprising a propylene-based elastomer and a polyalphaolefin, methods of making the same, and articles made therefrom.

### BACKGROUND OF THE INVENTION

Propylene-based elastomers are widely used as an impact modifier in propylene polymer materials for improving impact resistance and achieving high filler loading while maintaining flexibility and durability, which are desirable properties for various applications. However, use of propylene-based elastomers under low temperatures below −30° C. may be limited by their glass transition temperature, typically of about −20° C. Currently, copolymers of ethylene and another alpha-olefin, usually butene, hexene, or octene, which has a lower glass transition temperature, are common alternatives to propylene-based elastomers for applications where low-temperature impact resistance is desirable.

U.S. Pat. No. 7,307,125 relates to a thermoplastic polymer composition including a blend of highly crystalline polypropylene homopolymer, an ethylene-C₄₋₈ α-olefin plastomer and talc, wherein the blend has a D₅₀ of about 2.0 μm or less. The thermoplastic polymer composition is said to exhibit post injection molding shrinkage, low temperature impact strength, and tensile strength that is similar to or better than relatively expensive engineering resins and blends.

U.S. Pat. No. 6,803,415 discloses flexible compositions having no elastomeric fractions comprising: A) from 10 to 90 parts by weight of random copolymer of propylene and at least one comonomer selected from ethylene and C₄-C₈ alpha-olefins having a melting point of at least 100° C. and not exceeding 140° C. and a flow index measured at 230° C. under a weight of 2.16 kg (ASTM standard D1238, 1986) of from 0.5 to 15 g/10 min, and B) from 90 to 10 parts by weight of plastomer prepared with a metallocene catalyst and consisting of a random copolymer of ethylene and at least one C₃-C₁₀ alpha-olefin having a density of from 0.860 to 0.920 g/cm³, a melt flow index measured at 190° C. under a weight of 2.16 kg (ASTM standard D1238, 1986) of from 0.5 to 30 g/10 min, and a molecular weight distribution M_{w}/Mₙ of at most 4. These compositions are said to provide a compromise between flexibility and low-temperature impact resistance and heat resistance and are said to be suitable for producing flexible moldings and very particularly for the manufacture by extrusion of films, of flexible sheeting, and of cables.

U.S. Pat. No. 7,645,829 discloses a composition comprising: a random propylene polymer component having a heat of fusion of between 1 and 70 J/g and an mm triad tacticity index of at least 75%; and a functionalized polymer component comprising a C₂-C₂₀ olefin comprising at least 0.1 wt % of a functional group; and a non-functionalized plasticizer, which preferably comprises polyalphaolefin. However, it is only used for adhesive applications rather than others.

There remains a need for a polymer composition comprising a propylene-based elastomer as an impact modifier particularly useful in applications where low-temperature (e.g., −40° C.) impact resistance is desirable, which would overcome the bottleneck caused by the relatively low glass transition temperature of the propylene-based elastomer without significantly compromising benefits including flexibility, higher filler loading and good mechanical properties. Applicants have found that polyalphaolefins, when compounded with propylene-based elastomers, can provide a glass transition temperature below −30° C. and reduce hardness, thus, improving impact resistance performance at a temperature as low as −40° C. for the final composition. Meanwhile, a high filler loading generated as a concurrent advantage, such as up to about 90 wt % of the composition, enables a competitive cost for industries including, e.g., automotive applications.

### SUMMARY OF THE INVENTION

Disclosed herein are compositions comprising a propylene-based elastomer and a polyalphaolefin, methods of making the same, and articles made therefrom. In one embodiment, the present invention encompasses a composition comprising: (a) a propylene-based elastomer, comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (b) a polyalphaolefin, wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

In one embodiment, the present invention relates to a method for preparing a composition, comprising the steps of (a) combining (i) a propylene-based elastomer comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (ii) a polyalphaolefin, and (b) forming the composition, wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

The present invention also encompasses an article comprising any of the compositions described herein or made according to any method disclosed herein. Preferably, the article is selected from the group consisting of bumper, bumper fascia; exterior body panel, door panel, grill, exterior trim, body side molding, side cladding, side molding, end cap, hood, deck lid, mirror housing, roof rack, wheel cover, wheel liner, wheel flare, fender liner, hub cap, running board, step pad, sill plate, air dam, splash shield, mud guard, bed liner, and rocker panel; fuel tank; interior trim, including steering column cover, console, door panel, pillar, support, knob, button, handle, safety screen, instrument panel, dash board, knee bolster; passenger side airbag cover, headliner, glove box, tray, cup holder, compartment, lid, seat component, back, support, safety belt securing device, under-hood part, battery tray, fan shroud, electrical housing; cable bearing, structural component, door carrier, truck bed separator, load floor, and trunk divider.

In one embodiment, the present invention relates to a vehicle comprising any of the compositions described herein, wherein the vehicle is selected from the group consisting of car, truck, bus, boat, all-terrain vehicle, personal water craft, golf cart, snowmobile, motorcycle, moped, tractor, mower, wagon, bicycle, airplane, helicopter, train, military machine, and gondola car.

In one embodiment, the present invention relates to a method for lowering the glass transition temperature of a formulation comprising a propylene-based elastomer, said method comprising the steps of (a) combining (i) the formulation comprising a propylene-based elastomer, said propylene-based elastomer comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (ii) a polyalphaolefin, and (b) forming a composition, wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

### DETAILED DESCRIPTION OF THE INVENTION

Various specific embodiments, versions of the present invention will now be described, including preferred embodiments and definitions that are adopted herein. While the following detailed description gives specific preferred embodiments, those skilled in the art will appreciate that these embodiments are exemplary only, and that the present invention can be practiced in other ways. Any reference to the “invention” may refer to one or more, but not necessarily all, of the present inventions defined by the claims. The use of headings is for purposes of convenience only and does not limit the scope of the present invention.

As used herein, when a polymer or oligomer is referred to as comprising a monomer, the monomer present in the polymer or oligomer is the polymerized or oligomerized form of the monomer, respectively. The term “polymer” is meant to encompass homopolymers and copolymers. The term copolymer includes any polymer having two or more different monomers in the same chain, and encompasses random copolymers, statistical copolymers, interpolymers, and block copolymers.

As used herein, when a polymer composition or blend is said to comprise a certain percentage, wt %, of a monomer, that percentage of monomer is based on the total amount of monomer units in all the polymer components of the composition or blend. For example, if a composition or blend comprises 50 wt % of polymer A, which has 20 wt % monomer X, and 50 wt % of a polymer B, which has 10 wt % monomer X, the composition or blend comprises 15 wt % of monomer X.

As used herein, “elastomer” or “elastomeric composition” refers to any polymer or composition of polymers (such as blends of polymers) consistent with the ASTM D1566 definition. Elastomer includes mixed blends of polymers such as melt mixing and/or reactor blends of polymers. The terms may be used interchangeably with the term “rubber(s).”

A “polyolefin” is a polymer comprising at least 50 mol % of one or more olefin monomers. Preferably, a polyolefin comprises at least 60 mol % (preferably at least 70 mol %, preferably at least 80 mol %, preferably at least 90 mol %, preferably at least 95 mol %, preferably 100 mol %) of one or more olefin monomers, preferably 1-olefins, having carbon numbers of 2 to 20 (preferably 2 to 16, preferably 2 to 10, preferably 2 to 8, preferably 2 to 6). Preferably, a polyolefin has an Mₙ of 20 kg/mol or more, preferably 40 kg/mol or more (preferably 60 kg/mol or more, preferably 80 kg/mol or more, preferably 100 kg/mol or more).

As used herein, when a “formulation” is said to comprise a certain component, the formulation may comprise only that component and does not necessarily comprise other components.

As used herein, a “low temperature” refers to a temperature usually below about −30° C., preferably as low as −40° C., which is the condition chosen for impact resistance test in the present invention, especially intended for applications in automotive industry.

As used herein, the term “free of” means that the compound in question is not added deliberately to the composition and, if present, is present at less than 1 wt %, preferably less than 0.5 wt %, preferably less than 0.1 wt %, preferably less than 0.05 wt %, preferably less than 0.01 wt %, based on the total weight of the composition.

The present invention relates to a composition comprising a propylene-based elastomer and a polyalphaolefin, preferably for low-temperature applications. The polyalphaolefin, when compounded with the propylene-based elastomer can reduce hardness and improve glass transition temperature of the inventive composition, thus, conferring an impact resistance under a temperature below −30° C.

In one embodiment, the present invention encompasses a composition comprising: (a) a propylene-based elastomer, comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (b) a polyalphaolefin, wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

### Propylene-Based Elastomer

The propylene-based elastomer of the present invention is a copolymer of propylene-derived units and units derived from at least one of ethylene or a C₄₋₁₀ alpha-olefin. The copolymer may contain at least about 60 wt % propylene-derived units of the propylene-based elastomer. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The units, or comonomers, derived from at least one of ethylene or a C₄₋₁₀ alpha-olefin may be present in an amount of about 1 to about 35 wt %, or about 5 to about 35 wt %, preferably about 7 to about 32 wt %, more preferably about 8 to about 25 wt %, even more preferably about 8 to about 20 wt %, and most preferably about 8 to about 18 wt % of the propylene-based elastomer. The comonomer content may be adjusted so that the propylene-based elastomer has a heat of fusion of less than about 80 J/g, a melting point of about 105° C. or less, and a crystallinity of about 2% to about 65% of isotactic polypropylene, and a melt flow rate (MFR) of about 2 to about 20 g/min.

The propylene-based elastomer may comprise more than one comonomer. Preferred embodiments of a propylene-based elastomer having more than one comonomer include propylene-ethylene-octene, propylene-ethylene-hexene, and propylene-ethylene-butene polymers. In some embodiments where more than one comonomer derived from at least one of ethylene or a C₄₋₁₀ alpha-olefin is present, the amount of one comonomer may be less than about 5 wt % of the propylene-based elastomer, but the combined amount of comonomers of the propylene-based elastomer is about 5 wt % or greater.

In a preferred embodiment, the comonomer is ethylene, 1-hexene, or 1-octene. In one embodiment, the propylene-based elastomer comprises ethylene-derived units. The propylene-based elastomer may comprise about 5 to about 25 wt %, preferably about 8 to about 20 wt %, or about 9 to about 16 wt % ethylene-derived units of the propylene-based elastomer. In some embodiments, the propylene-based elastomer consists essentially of units derived from propylene and ethylene, i.e., the propylene-based elastomer does not contain any other comonomer in an amount typically present as impurities in the ethylene and/or propylene feedstreams used during polymerization or an amount that would materially affect the heat of fusion, melting point, crystallinity, or melt flow rate of the propylene-based elastomer, or any other comonomer intentionally added to the polymerization process.

The propylene-based elastomer may have a triad tacticity of three propylene units, as measured by ¹³C NMR, of at least about 75%, at least about 80%, at least about 82%, at least about 85%, or at least about 90%. Preferably, the propylene-based elastomer has a triad tacticity of about 50 to about 99%, about 60 to about 99%, more preferably, about 75 to about 99% or about 80 to about 99%. In some embodiments, the propylene-based elastomer may have a triad tacticity of about 60 to 97%.

The propylene-based elastomer has a heat of fusion (“H_{f}”), as determined by DSC, of about 80 J/g or less, preferably about 70 J/g or less, about 50 J/g or less, or about 35 J/g or less. The propylene-based elastomer may have a lower limit H_{f} of about 0.5 J/g, about 1 J/g, or about 5 J/g. For example, the H_{f} value may be anywhere from 1.0, 1.5, 3.0, 4.0, 6.0, or 7.0 J/g, to 30, 35, 40, 50, 60, 70, 75, or 80 J/g.

The propylene-based elastomer may have a percent crystallinity, as determined according to the DSC procedure described herein, of about 2 to about 65%, preferably about 0.5 to about 40%, preferably about 1 to about 30%, and more preferably about 5 to about 35%, of isotactic polypropylene. The thermal energy for the highest order of propylene (i.e., 100% crystallinity) is estimated at 189 J/g. In some embodiments, the copolymer has crystallinity less than 40%, in the range of about 0.25 to about 25%, or about 0.5 to about 22% of isotactic polypropylene. Embodiments of the propylene-based elastomer may have a tacticity index m/r from a lower limit of about 4 or about 6 to an upper limit of about 8 or about 10 or about 12. In some embodiments, the propylene-based elastomer has an isotacticity index greater than 0%, or within the range having an upper limit of about 50% or about 25%, and a lower limit of about 3% or about 10%.

In some embodiments, crystallinity of the propylene-based elastomer is reduced by copolymerization of propylene with limited amounts of one or more comonomers selected from: ethylene, C₄₋₂₀ alpha-olefins, and polyenes. In these copolymers, the amount of propylene-derived units present in the propylene-based elastomer ranges from an upper limit of about 95 wt %, about 94 wt %, about 92 wt %, about 90 wt %, or about 85 wt %, to a lower limit of about 60 wt %, about 65 wt %, about 70 wt %, about 75 wt %, about 80 wt %, about 84 wt %, or about 85 wt % of the propylene-based elastomer.

The optional polyene may be any hydrocarbon structure having at least two unsaturated bonds wherein at least one of the unsaturated bonds is readily incorporated into a polymer. For example, the optional polyene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkyliene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of optional polyene-derived units present in the propylene-based elastomer ranges from an upper limit of about 15%, about 10%, about 7%, about 5%, about 4.5%, about 3%, about 2.5%, or about 1.5%, to a lower limit of about 0%, about 0.1%, about 0.2%, about 0.3%, about 0.5%, or about 1%, based on the total weight of the propylene-based elastomer. In a preferred embodiment, the propylene-based elastomer does not contain any diene-derived units (as used herein, “diene”).

The propylene-based elastomer may have a single peak melting transition as determined by DSC. In one embodiment, the copolymer has a primary peak transition of about 90° C. or less, with a broad end-of-melt transition of about 110° C. or greater. The peak “melting point” (“Tₘ”) is defined as the temperature of the greatest heat absorption within the range of melting of the sample. However, the copolymer may show secondary melting peaks adjacent to the principal peak, and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of about 110° C. or less, about 105° C. or less, about 100° C. or less, about 90° C. or less, about 80° C. or less, or about 70° C. or less. In one embodiment, the propylene-based elastomer has a Tₘ of about 25 to about 105° C., preferably about 60 to about 105° C., about 70 to about 105° C., or about 90 to about 105° C.

The propylene-based elastomer may have a density of about 0.850 to about 0.920 g/cm³, about 0.860 to about 0.900 g/cm³, preferably about 0.860 to about 0.880 g/cm³, at room temperature as measured per ASTM D1505.

The propylene-based elastomer may have a melt flow rate (“MFR”), as measured per ASTM D1238, 2.16 kg at 230° C., of at least about 2 g/10 min. In one embodiment, the propylene-based elastomer has an MFR about 2 to about 20 g/10 min, about 2 to about 10 g/10 min, or about 2 to about 5 g/10 min.

The propylene-based elastomer may have an Elongation at Break of less than about 2000%, less than about 1000%, or less than about 800%, as measured per ASTM D412.

The propylene-based elastomer may have a weight average molecular weight (M_{w}) of about 5,000 to about 5,000,000 g/mole, preferably about 10,000 to about 1,000,000 g/mole, and more preferably about 50,000 to about 400,000 g/mole; a number average molecular weight (Mₙ) of about 2,500 to about 250,000 g/mole, preferably about 10,000 to about 250,000 g/mole, and more preferably about 25,000 to about 200,000 g/mole; and/or a z-average molecular weight (M_{z}) of about 10,000 to about 7,000,000 g/mole, preferably about 80,000 to about 700,000 g/mole, and more preferably about 100,000 to about 500,000 g/mole. The propylene-based elastomer may have a molecular weight distribution (“MWD”) of about 1.5 to about 20, or about 1.5 to about 15, preferably about 1.5 to about 5, and more preferably about 1.8 to about 3, and most preferably about 1.8 to about 2.5.

Preferred propylene-based elastomers are available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins of the Netherlands). The particular grade(s) of commercially available propylene-based elastomer suitable for use in the invention can be readily determined using methods commonly known in the art.

The composition of the invention, e.g., a masterbatch, may include one or more different propylene-based elastomers, i.e., propylene-based elastomers each having one or more different properties such as, for example, different comonomer or comonomer content. Such combinations of various propylene-based elastomers are all within the scope of the invention.

In certain embodiments, the propylene-based elastomer is an elastomer including propylene-crystallinity, a melting point by DSC equal to or less than 105° C., and a H_{f} of from about 5 J/g to about 30 J/g. The propylene-derived units are present in an amount of about 80 to about 90 wt %, based on the total weight of the propylene-based elastomer. The ethylene-derived units are present in an amount of about 9 to about 18 wt %, for example, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5, about 18 wt %, based on the total weight of the propylene-based elastomer. The propylene-based elastomer can be present in an amount of about 2 to about 98 wt %, preferably about 2 to about 60 wt %, particularly from a lower limit of about 2, about 7, about 12, about 17, about 22, about 27 wt %, to an upper limit of about 32, about 37, about 42, about 47, about 52, about 57, about 60 wt % of the composition of the present invention, or in the range of any of the combinations of the values recited herein.

The propylene-based elastomer may comprise copolymers prepared according to the procedures described in WO 02/36651, U.S. Pat. No. 6,992,158, and/or WO 00/01745, the contents of which are incorporated herein by reference. Preferred methods for producing the propylene-based elastomer may be found in U.S. Pat. Nos. 7,232,871 and 6,881,800, the contents of which are incorporated herein by reference. The invention is not limited by any particular polymerization method for preparing the propylene-based elastomer, and the polymerization processes are not limited by any particular type of reaction vessel.

### Polyalphaolefin

The composition of the present invention may include at least one polyalphaolefin (“PAO”). In general, PAOs are oligomers of α-olefins (also known as 1-olefins) and are often used as the base stock for synthetic lubricants. PAOs are typically produced by the polymerization of alpha-olefins, preferably linear alpha-olefins. A PAO may be characterized by any type of tacticity, including isotactic or syndiotactic and/or atactic, and by any degree of tacticity, including isotactic-rich or syndiotactic-rich or fully atactic. PAO liquids are described in, for example, U.S. Pat. Nos. 3,149,178; 4,827,064; 4,827,073; 5,171,908; and 5,783,531 and in SYNTHETIC LUBRICANTS AND HIGH-PERFORMANCE FUNCTIONAL FLUIDS, Leslie R. Rudnick & Ronald L. Shubkin, eds. (Marcel Dekker, 1999), pp. 3-52. PAOs are Group 4 compounds, as defined by the American Petroleum Institute (API).

Useful PAOs may be made by any suitable means known in the art, and the invention is not herein limited by the manufacturing method. The PAOs may be prepared by the oligomerization of an alpha-olefin in the presence of a polymerization catalyst, such as a Friedel-Crafts catalyst (including, for example, AlCl₃, BF₃, and complexes of BF₃ with water, alcohols, carboxylic acids, or esters), a coordination complex catalyst (including, for example, the ethylaluminum sesquichloride+TiCl₄ system), or a homogeneous or heterogeneous (supported) catalyst more commonly used to make polyethylene and/or polypropylene (including, for example, Ziegler-Natta catalysts, metallocene or other single-site catalysts, and chromium catalysts). Subsequent to the polymerization, the PAO may be hydrogenated in order to reduce any residual unsaturation. PAOs may be hydrogenated to yield substantially (>99 wt %) paraffinic materials. The PAO's may also be functionalized to comprise, for example, esters, polyethers, polyalkylene glycols, and the like.

In general, PAOs are high purity hydrocarbons with a paraffinic structure and a high-degree of side-chain branching. The PAO may have irregular branching or regular branching. The PAO may comprise oligomers or low molecular weight polymers of branched and/or linear alpha olefins. In one embodiment, the PAO comprises C₆ to C₂₀₀₀, or C₁₅ to C₁₅₀₀, or C₂₀ to C₁₀₀₀, or C₃₀ to C₈₀₀, or C₃₅ to C₄₀₀, or C₄₀ to C₂₅₀ oligomers of alpha-olefins. These oligomers may be dimers, trimers, tetramers, pentamers, etc. In another embodiment, the PAO comprises C₂ to C₂₄, preferably C₅ to C₁₈, more preferably C₆ to C₁₄, even more preferably C₈ to C₁₂, most preferably C₁₀ branched or linear alpha-olefins. In another embodiment, the PAO comprises C₃ to C₂₄, preferably C₅ to C₈, more preferably C₆ to C₁₄, most preferably C₈ to C₁₂ linear alpha-olefins (LAOs). Suitable olefins include ethylene, propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, and blends thereof. Oligomers of LAOs with only even carbon numbers between 6 and 18 (inclusive) are particularly preferred. Preferably, C₂, C₃, and C₄ alpha-olefins (i.e., ethylene, propylene and 1-butene and/or isobutylene) are present in the PAO oligomers at an average concentration of 30 wt % or less, or 20 wt % or less, or 10 wt % or less, or 5 wt % or less; more preferably, C₂, C₃, and C₄ alpha-olefins are not present in the PAO oligomers. Useful PAOs are described more particularly in, for example, U.S. Pat. No. 5,171,908 and U.S. Pat. No. 5,783,531, both of which are herein incorporated by reference.

In one embodiment, a single LAO is used to prepare the oligomers. In this case, a preferred embodiment involves the oligomerization of 1-decene, and the PAO is a mixture of oligomers (including, for example, dimers, trimers, tetramers, pentamers, and higher) of 1-decene. In another embodiment, the PAO comprises oligomers of two or more C₃ to C₁₈ LAOs (preferably C₅ to C₁₈ LAOs), to make ‘bipolymer’ or ‘terpolymer’ or higher-order copolymer combinations, provided that C₃ and C₄ LAOs are present at 10 wt % or less. In this case, a preferred embodiment involves the oligomerization of a mixture of 1-octene, 1-decene, and 1-dodecene, and the PAO is a mixture of oligomers (for example, dimers, trimers, tetramers, pentamers, and higher) of 1-octene/1-decene/1-dodecene ‘terpolymer’.

In another embodiment, the PAO comprises oligomers of a single alpha-olefin species having a carbon number of 5 to 24 (preferably 6 to 18, preferably 8 to 12, most preferably 10). In another embodiment, the PAO comprises oligomers of mixed alpha-olefins (i.e., involving two or more alpha-olefin species), each alpha-olefin having a carbon number of 3 to 24 (preferably 5 to 24, preferably 6 to 18, most preferably 8 to 12), provided that alpha-olefins having a carbon number of 3 or 4 are present at 10 wt % or less. In a particularly preferred embodiment, the PAO comprises oligomers of mixed alpha-olefins (i.e., involving two or more alpha-olefin species) where the weighted average carbon number for the alpha-olefin mixture is 6 to 14 (preferably 8 to 12, preferably 9 to 11).

In another embodiment, the PAO comprises oligomers of one or more alpha-olefin with repeat unit formulas of

—[CHR—CH₂]—

where R is a C₃ to C₁₈ saturated hydrocarbon branch. Preferably, R is constant for all oligomers. In another embodiment, there is a range of R substituents covering carbon numbers from 3 to 18. Preferably, R is linear, i.e.,

R is (CH₂)_{z}CH₃,

where z is 2 to 17 (preferably 3 to 11, preferably 4 to 9).

Optionally, R may contain one methyl or ethyl branch, i.e.,

R is (CH₂)ₘ[CH(CH₃)](CH₂)ₙCH₃ or (CH₂)ₓ[CH(CH₂CH₃)](CH₂)_{y}CH₃,

where (m+n) is 1 to 15 (preferably 1 to 9, preferably 3 to 7) and (x+y) is 1 to 14 (preferably 1 to 8, preferably 2 to 6). Preferably m>n. Preferably m is 0 to 15 (preferably 2 to 15, preferably 3 to 12, preferably 4 to 9) and n is 0 to 10 (preferably 1 to 8, preferably 1 to 6, preferably 1 to 4). Preferably x>y. Preferably x is 0 to 14 (preferably 1 to 14, preferably 2 to 11, preferably 3 to 8) and y is 0 to 10 (preferably 1 to 8, preferably 1 to 6, preferably 1 to 4). Preferably, the repeat units are arranged in a head-to-tail fashion with minimal heat-to-head connections.

The PAO may be atactic, isotactic, or syndiotactic. In one embodiment, the PAO has essentially the same population of meso [m] and racemic [r] dyads (preferably neither [m] nor [r] greater than 60%, preferably neither greater than 55%) as measured by ¹³C-NMR, making it atactic. In another embodiment, the PAO has more than 60% (preferably more than 70%, preferably more than 80%, preferably more than 90%) meso dyads [m]. In another embodiment, the PAO has more than 60% (preferably more than 70%, preferably more than 80%, preferably more than 90%) racemic dyads [r]. In one embodiment, [m]/[r] determined by ¹³C-NMR is between 0.9 and 1.1 in one embodiment, [m]/[r] is greater than 1 in another embodiment, and [m]/[r] is less than 1 in yet another embodiment.

Preferred PAOs have a “branching ratio” as defined in U.S. Pat. No. 4,827,064 and measured according to the method described therein, of 0.20 or less, preferably 0.19 or less, preferably 0.18 or less, preferably 0.17 or less, preferably 0.15 or less, preferably 0.12 or less, preferably 0.10 or less.

Useful PAOs typically possess a number average molecular weight (Mₙ) in the range of 100 to 21,000, or 300 to 15,000, or in the range of 200 to 10,000, or 200 to 7,000, or 600 to 3,000, or more preferably 200 to 2,000, or more preferably 200-500 g/mole. Useful PAOs have a weight average molecular weight (M_{w}) of less than 20,000 g/mol, or less than 10,000 g/mol, or less than 5,000 g/mol, or more preferably less than 4,000 g/mol, or less than 2,000 g/mol, or less than 500 g/mol. In some embodiments, the PAO may have an M_{w} of 1000 g/mole or more, or 2000 g/mole or more, or 2500 g/mole or more, or 3000 g/mole or more, or 3500 g/mole or more. In other embodiments the PAO may have an M_{w} in the range of 100 to 20,000 g/mol, or 200 to 10,000 g/mol, or 200 to 7,000 g/mol. In another embodiment, the PAO may have an M_{w} in the range of 2000 g/mole to 4000 g/mole, or in the range of 2500 g/mole to 3500 g/mole. In one or more embodiments, the PAO or blend of PAOs has a molecular weight distribution as characterized by the ratio of the weight- and number-averaged molecular weights (M_{w}/Mₙ) of 4 or less, or 3 or less, or 2.5 or less, or 2.3 or less, or 2.1 or less, or 2.0 or less, or 1.9 or less, or 1.8 or less. In other embodiments, the PAO or blend of PAOs has an M_{w}/Mₙ in the range of 1 to 2.5, preferably 1.1 to 2.3, or 1.1 to 2.1, or 1.1 to 1.9.

In a preferred embodiment, the PAO has a kinematic viscosity (“KV”) at 100° C., as measured by ASTM D445 at 100° C., of 3 cSt (1 cSt=1 mm²/s) or more, preferably 5 cSt or more, preferably 6 cSt or more, preferably 8 cSt or more, preferably 10 cSt or more, preferably 20 cSt or more, preferably 30 cSt or more, preferably 40 cSt or more, preferably 100 or more, preferably 150 cSt or more. In another embodiment, the PAO has a KV at 100° C. of 300 cSt or less, preferably 100 cSt or less. In another embodiment, the PAO has a KV at 100° C. of 3 to 3,000 cSt, preferably 4 to 1,000 cSt, preferably 6 to 300 cSt, preferably 8 to 150 cSt, preferably 8 to 100 cSt, preferably 8 to 40 cSt. In another embodiment, the PAO has a KV at 100° C. of 10 to 1000 cSt, preferably 10 to 300 cSt, preferably 10 to 100 cSt. In yet another embodiment, the PAO has a KV at 100° C. of about 4 to 8 cSt. In yet another embodiment, the PAO has a KV at 100° C. of 1 to 3 cSt.

In another preferred embodiment, the PAO has a viscosity index (“VI”), as determined by ASTM D2270, of 90 or more, or 100 or more, or 110 or more, or 115 or more, or 120 or more, or 130 or more, or 140 or more, or 150 or more, or 170 or more, or 190 or more, or 200 or more, or 250 or more, or 300 or more. Preferred ranges for VI include 90 to 400, or in the range of 120 to 350, or 130 to 250, or 100 to 180, or preferably 110 to 150, or more preferably 120 to 140.

In yet another preferred embodiment, the PAO has a pour point of −10° C. or less, preferably −20° C. or less, preferably −25° C. or less, preferably −30° C. or less, preferably −35° C. or less, preferably −40° C. or less, preferably −50° C. or less. In another embodiment, the PAO or blend of PAOs has a pour point of −15 to −70° C., preferably −25 to −60° C.

In yet another preferred embodiment, the PAO has a glass transition temperature (T_{g}) of −40° C. or less, preferably −50° C. or less, preferably −60° C. or less, preferably −70° C. or less, preferably −80° C. or less. In another embodiment, the PAO or blend of PAOs has a T_{g} of −50 to −120° C., preferably −60 to −100° C., preferably −70 to −90° C.

In yet another preferred embodiment, the PAO has a flash point of 200° C. or more, preferably 210° C. or more, preferably 220° C. or more, preferably 230° C. or more, preferably between 240° C. and 290° C.

In yet another preferred embodiment, the PAO has a specific gravity (15.6/15.6° C.) of 0.86 or less, preferably 0.855 or less, preferably 0.85 or less, preferably 0.84 or less.

Particularly preferred PAOs are those having (a) a flash point of 200° C. or more, preferably 210° C. or more, preferably 220° C. or more, preferably 230° C. or more; and (b) a pour point less than −20° C., preferably less than −25° C., preferably less than −30° C., preferably less than −35° C., preferably less than −40° C. and/or a KV at 100° C. of 8 cSt or more, preferably 10 cSt or more, preferably 35 cSt or more, preferably 40 cSt or more, preferably 50 cSt or more.

Further preferred PAOs have a KV at 100° C. of at least 3 cSt, preferably at least 6 cSt, preferably at least 8 cSt, most preferably at least 10 cSt; a VI of at least 120, preferably at least 130, preferably at least 140, most preferably at least 150; a pour point of −10° C. or less, preferably −20° C. or less, preferably −30° C. or less, most preferably −40° C. or less; and a specific gravity (15.6/15.6° C.) of 0.86 or less, preferably 0.855 or less, preferably 0.85 or less, most preferably 0.84 or less.

The PAO may be comprised of one or more distinct PAO components. In one embodiment, the PAO is a blend of one or more oligomers with different compositions (e.g., different α-olefin(s) were used to make the oligomers) and/or different physical properties (e.g., KV, pour point, VI, and/or T_{g}).

In one embodiment of the present invention, the PAO is present in an amount of about 2 to about 98 wt %, preferably about 2 to about 60 wt %, more preferably about 2 to about 30 wt %, particularly from a lower limit of about 5, about 10, about 15 wt %, to an upper limit of about 20, about 25 about 30 wt % of the composition, or in the range of any of the combinations of the values recited herein.

Desirable PAOs are available as SpectraSyn™ and SpectraSyn Ultra™ (previously sold under the SHF and SuperSyn™ tradenames) from ExxonMobil Chemical Company (Houston, Tex., USA). Other useful PAOs include Synfluid™ available from ChevronPhillips Chemical Company (Pasadena, Tex., USA), Durasyn™ available from Innovene (Chicago, Ill., USA), Nexbase™ available from Neste Oil (Keilaniemi, Finland), and Synton™ available from Chemtura Corporation (Middlebury, Conn., USA). The percentage of carbons in chain-type paraffinic structures (C_{P}) is close to 100% (typically greater than 98% or even 99%) for PAOs.

### Thermoplastic Polyolefin

In one embodiment of the present invention, the composition may further comprise a thermoplastic polyolefin. Said thermoplastic polyolefin is distinct from the PAO discussed above. Depending on the type and amount of the thermoplastic polyolefin, the final polymer composition may have thermoplastic, elastomeric, or thermoplastic elastomeric properties.

Thermoplastic polyolefins suitable for use in the composition of the present invention include thermoplastic, crystalline polyolefin homopolymers and copolymers. They are desirably prepared from monoolefin monomers having 2 to 7 carbon atoms, such as ethylene, propylene, 1-butene, isobutylene, 1-pentene, 1-hexene, 1-octene, 3-methyl-1-pentene, 4-methyl-1-pentene, 5-methyl-1-hexene, mixtures thereof and copolymers thereof with (meth)acrylates and/or vinyl acetates. Preferred, however, are monomers having 3 to 6 carbon atoms, with propylene being most preferred. As used in the specification and claims the term polypropylene includes homopolymers of propylene as well as copolymers comprising propylene. Copolymers comprising propylene refer to reactor copolymers of polypropylene (reacted blends) and random copolymers containing more than 94% by weight of propylene, the remainder being selected from the comonomers (other than propylene) mentioned above, preferably ethylene. Typically, the random copolymers of polypropylene with ethylene contain about 1 to about 6 wt %, preferably less than about 6 wt % of ethylene and/or about 1 to about 30 wt % of an alpha-olefin comonomer of 4 to 16 carbon atoms, and mixtures thereof. The polypropylene can be highly crystalline isotactic or syndiotactic polypropylene. Commercially available polyolefins may be used in the practice of the present invention. Further polyolefins which can be used in terms of the invention are high, low, linear-low, very low-density polyethylenes, and copolymers of ethylene with (meth)acrylates, and/or vinyl acetates.

The thermoplastic polyolefins mentioned above can be made by conventional Ziegler-Natta catalyst systems or by single-site catalyst systems, including polyolefins such as polyethylene copolymers obtained by metallocene catalysis with butene, hexane, or octene as the comonomer. The amount of comonomer present in a polyethylene copolymer determines the density of the copolymer. Metallocene polymers or plastomers refer to polymers or plastomers prepared using a class of well-known highly active olefin catalysts known as metallocenes. These catalysts, particularly those based on group IV B transition metals such as zirconium, titanium, and hafnium, show high activity in ethylene polymerization. The metallocene catalysts are also flexible in that, by manipulation of catalyst composition and reaction conditions, they can provide polyolefins with controllable molecular weights, as low as about 200 up to about 1 million or higher, and molecular weight distribution, from extremely narrow to broad. Exemplary of the development of metallocene catalysts for the polymerization of ethylene is found in U.S. Pat. No. 4,937,299 to Ewen et al., hereby incorporated by reference. Metallocene catalysts are useful in making controlled ultra-uniform and super random specialty copolymers. For example, if a lower density ethylene copolymer is made with a metallocene catalyst, such as very low density polyethylene (VLDPE), an ultra-uniform and super random copolymerization will occur, as contrasted with the polymer produced by copolymerization using a conventional Ziegler catalyst.

The thermoplastic polyolefin included may be present in an amount of about 1 to about 5 wt %, for example, about 1, about 2, about 3, about 4, or about 5 wt %, based on the total weight of the composition.

### Filler

The composition of the present invention may include at least one filler. The classes of materials described herein that are useful as fillers can be utilized alone or admixed to obtain desired properties. In any of the embodiments, the filler may be present at about 20 to about 90 wt %, preferably 40 to 75 wt %, more preferably 50 to 60 wt %, based on the total weight of the composition.

Desirable fillers can be organic fillers and/or inorganic fillers. Organic fillers include such materials as carbon black, fly ash, graphite, cellulose, starch, flour, wood flour, and polymeric fibers like polyester-based, polyamide-based materials, etc.

Preferred examples of inorganic fillers are calcium carbonate, talc, glass fibers, marble dust, cement dust, clay, feldspar, silica or glass, fumed silica, alumina, magnesium oxide, antimony oxide, zinc oxide, barium sulfate, calcium sulfate, aluminum silicate, calcium silicate, titanium dioxide, titanates, clay, nanoclay, organo-modified clay or nanoclay, glass microspheres, and chalk. Of these fillers, calcium carbonate, barium sulfate, antimony oxide, talc, silica/glass, glass fibers, alumina, aluminum trihydroxide, magnesium hydroxide and titanium dioxide, and mixtures thereof are preferred.

For some applications the use of two or more fillers is preferred. Examples of useful filler blends include barium sulfate and calcium carbonate for sound barriers, and carbon black and calcium carbonate and/or talc for conductive flooring. The respective amount of each filler in these blends is well within the skill of the ordinary artisan.

### Properties

The composition of the present invention exhibits advantageous properties especially favoring low-temperature applications, the properties including at least one of the following: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

In one embodiment, the composition described herein has a hardness, as measured by ASTM D2240, of about 25 to about 67 shore A, for example, from about 25, about 27, about 29, about 31, about 33, about 35, about 37, about 39, up to about 42, about 46, about 50, about 54, about 58, about 62, about 67 shore A. The PAO, especially when blended into the composition in an amount of about 2 to about 30 wt % of the composition, can reduce the hardness of the neat material of the propylene-based elastomer having a hardness of about 67 shore A, thus, providing the final composition desirable softness for applications requiring flexibility. Preferably, the composition is capable of maintaining good other physical properties, including at least one of the following: (a) a 100% modulus (measured by ASTM D412) above about 140 psi; (b) a tensile strength (measured by ASTM D412) above about 500 psi; (c) a tear resistance (measured by ASTM D624) above about 15 kN/m; (d) an elongation at break (measured by ASTM D412) above about 950%; and (e) a specific gravity (measured by ASTM D792) above about 1.0 g/cc.

In another embodiment, the composition described herein has a glass transition temperature (T_{g}), measured at 10° C./min according to ASTM D3418-08, of about −35° C. to about −65° C., for example, ranging from a lower limit of about −35° C., about −36° C., about −37° C., about −38° C., about −39° C., about −40° C., about −41° C., about −42° C., about −43° C., about −44° C., about −45° C., about −46° C., to an upper limit of about −54° C., about −55° C., about −56° C., about −57° C., about −58° C., about −59° C., about −60° C., about −61° C., about −62° C., about −63° C., about −64° C., about −65° C., or in the range of any of the combinations of the values recited herein. Again, the PAO, especially when blended into the composition in an amount of about 2 to about 30 wt % of the composition, plays a role of improving T_{g} of a composition free of the PAO but otherwise identical in terms of its constituents.

In yet another embodiment, the composition described herein shows an impact resistance at a temperature no lower than about −40° C., as measured by ASTM D3763. Compared with a composition free of the PAO but otherwise identical in terms of its constituents, the composition comprising the PAO, especially in an amount of about 2 to about 30 wt %, demonstrates ductility modes at a temperature as low as −40° C., which is the specific temperature chosen for impact resistance test of automotive applications.

### Methods for Making the Composition

Also provided are methods for making the composition of the present invention. In one embodiment, the present invention discloses a method for preparing a composition comprising the steps of: (a) combining (i) a propylene-based elastomer comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (ii) a polyalphaolefin; and (b) forming the composition; wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

The propylene-based elastomer(s), PAO(s), optionally, thermoplastic polyolefins) and filler(s), and other additives of the composition of the present invention can be combined using any suitable means known in the polymer processing art. Those skilled in the art will be able to determine the appropriate methods to enable intimate mixing while also achieving process economy. For example, all components can be combined by simple physical blending of constituent pellets and/or granules, since the forming of articles includes a (re)melting and mixing of the raw material(s). However, in some fabrication processes such as compression molding, little mixing of the raw material(s) occurs, and a pelletized melt blend would be preferred over simple physical blends of the constituent pellets and/or granules. In this case, the constituents are melt-blended first, to provide a compounded product.

The propylene-based elastomer(s), PAO(s), optionally thermoplastic polyolefins) and filler(s), and other additives can be blended by any suitable means. For example, they may be blended in a tumbler, continuous mixer, static mixer, batch mixer, extruder, or a combination thereof that is sufficient to achieve an adequate dispersion of the components. More particularly, the components may be blended by any suitable means to form the composition of the present invention, which is then suitable for further processing into useful articles.

Another method of blending the components may be to combine the components in a melt-blending (compounding) step and subsequently pelletizing the blend, using either an underwater pelletizer or a strand-cut approach (i.e., a water batch and dry pelletizer); these pellets are then used in a process to fabricate articles. This approach may involve an on-line “finishing” extruder associated with a polymerization unit, or it may involve an off-line “compounding” extruder dedicated to melt blending. Alternatively, the composition may be prepared by combining the components during a process used to fabricate articles, without first making a pelletized version of the composition; here, the PAO is added to other components in a production extruder, such as the extruder on an injection molding machine or on a continuous extrusion line, and thereafter directly processed into a film, sheet, fiber, profile, etc.

The blending may involve “dry blending” wherein the components are combined without melting. For example, one method is to contact the components in a tumbler or bowl mixer, such as a high-speed Henschel mixer. The dry blending step can then be followed, if desired, by melt blending in an extruder.

Another method of blending the components may also be to melt-blend the components in a batch mixer, such as a Banbury™ or Brabender™ mixer.

Yet another method of blending may be to melt blend the components in an extruder, such as a single-screw extruder or a twin-screw extruder. Extrusion technology for polymer blends is well known in the art, and is described in more detail in, for example, PLASTICS EXTRUSION TECHNOLOGY, F. Hensen, Ed. (Hanser, 1988), pp. 26-37, and in POLYPROPYLENE HANDBOOK, E. P. Moore, Jr. Ed. (Hanser, 1996), pp. 304-348.

PAO may be directly injected into the polymer melt using a liquid injection device at some point along the barrel, as in the case of a twin-screw extruder, or through an opening in a hollow screw shaft, as in the case of a single-screw extruder. PAO is preferably added downstream from the polymer melt zone, but alternatively the PAO can be added at a point where the polymer(s) have not fully melted yet. For example, in a twin-screw extruder, PAO can be injected after the first barrel section (preferably after the first third of the barrel, more preferably in the last third of the barrel). Preferably, PAO is added downstream of filler addition. An PAO addition point may be on top of conveying elements of screw, or on top of liquid mixing elements of screw, or prior to kneading elements of screw, or prior to liquid mixing elements of the screw. The extruder may have more than one (preferably two or three) PAO addition points along the barrel or screw shaft. Optionally, the PAO can be added via the extruder feed throat.

The components may also be blended by a combination of methods, such as dry blending followed by melt blending in an extruder, or batch mixing of some components followed by melt blending with other components in an extruder. One or more components may also be blended using a double-cone blender, ribbon blender, or other suitable blender, or in a Farrel Continuous Mixer (FCM™).

Blending may also involve a “masterbatch” approach, where the target PAO concentration is achieved by combining neat propylene-based elastomer(s) and optionally thermoplastic polyolefins) and fillers and/or additives with an appropriate amount of pre-blended masterbatch (i.e., a blend of the propylene-based elastomer, PAO, and optionally the thermoplastic polyolefin and the filler and additives that has been previously prepared at a higher concentration of PAO than desired in the final blend). This is a common practice in polymer processing, typically used for addition of color, additives, and fillers to final compositions. Dispersion (or “letdown”) of the masterbatch may take place as part of a processing step used to fabricate articles, such as in the extruder on an injection molding machine or on a continuous extrusion line, or during a separate compounding step.

Preferably, the composition is prepared by melt-blending the components in a continuous mixer, such as a twin screw mixer or a Farrel Continuous Mixer (FCM™). Mixing can be performed at temperatures well above the melting point of the elastomer and/or rubber used in the composition at a rate sufficient to allow the filler(s) to exfoliate and become uniformly dispersed within the polymer to form the composition. The key issue for preparation is pelletization. It may take an extended time to optimize pellet form due to high viscosity of the material. Cutter blades may need to be replaced often.

### Applications

The present invention encompasses an article comprising the compositions of the present invention, including consumer goods, industrial goods, construction materials, packaging materials, and automotive parts. The article may be made or formed by any useful discrete molding or continuous extrusion means for forming and shaping polyolefins known in the art, including: compression molding, injection molding, co-injection molding, gas-assisted injection molding, blow molding, multi-layer blow molding, injection blow molding, stretch blow molding, extrusion blow molding, transfer molding; cast molding, rotational molding, foam molding, slush molding, transfer molding, wet lay-up or contact molding, cast molding, cold forming matched-die molding, thermoforming, vacuum forming, film blowing, film or sheet casting, sheet extrusion, profile extrusion or co-extrusion, fiber spinning, fiber spunbonding, fiber melt blowing, lamination, calendering, coating, pultrusion, protrusion, draw reduction, foaming, or other forms of processing such as described in, for example, PLASTICS PROCESSING (Radian Corporation, Noyes Data Corp. 1986), or combinations thereof. Use of certain processes, such as film casting and thermoforming, allows for the possibility of benefits from uniaxial or biaxial orientation of the inventive material.

Desirable articles of manufacture made from compositions of the present invention are particularly useful in vehicles (such as car, truck, bus, boat, all terrain vehicle, personal water craft, golf cart, snowmobile, motorcycle, moped, tractor, mower, wagon, bicycle, airplane, helicopter, train, military machine, gondola car, and the like), including: bumper and bumper fascia; exterior body panel, door panel, and grill; exterior trim, including body side molding, side cladding and molding, end cap, hood, deck lid, mirror housing, roof rack, wheel cover, wheel liner, wheel flare, fender liner, hub cap, running board, step pad, sill plate, air dam, splash shield, mud guard, bed liner, and rocker panel; fuel tank; interior trim, including steering column cover, console, door panel, pillar, support, knob, button, handle, and safety screen; instrument panel and dash board; knee bolster; passenger side airbag cover; headliner; glove box, tray, cup holder, compartment, and lid; seat component, including back, support, and safety belt securing device; under-hood application, including battery tray and fan shroud; electrical housing; cable bearing; and structural component, including door carrier, truck bed separator, load floor, and trunk divider.

Further non-limiting examples of desirable articles of manufacture made from compositions of the invention include film, tape, sheet, fiber, tubing, pipe, coating, fabric (woven and nonwoven), tarp, agricultural barrier, packaging (durable and disposable), household appliance (washing machine, refrigerator, blender, air conditioner, etc.), furniture (indoor and outdoor, such as table, chair, bench, shelving, etc.), sporting equipment (ski, surfboard, skateboard, skate, boot, sled, scooter, kayak, paddle, etc.), solid wheel, stadium seating, amusement park ride, personal protective equipment (safety helmet, shin guard, etc.), emergency response equipment, cookware, utensil, tray, pallet, cart, tank, tub, pond liner, storage container (crate, pail, jar, bottle, etc.), toy, child car seat and booster chair, medical device, sportswear, luggage, tool housing (for drill, saw, etc.), electronics housing (for television, computer, phone, hand-held device, media player, stereo, radio, clock, etc.), building construction material (flooring, siding, roofing, counter top, electrical housing and connector, etc.), lighting, gardening equipment (handle on shovel, wheelbarrow, etc.), playground equipment, motor housing, pump housing, battery housing, instrument housing, switch, knob, button, handle, pet supply, laboratory supply, personal hygiene device (razor, brush, hairdryer, etc.), cleaning supply (broom, dust pan, etc.), musical instrument case, statue, trophy, artwork, costume jewelry, picture frame, eyeglass frame, plant pot, and firearm component.

The present invention also relates to a method for lowering the glass transition temperature of a formulation comprising a propylene-based elastomer, said method comprising the steps of: (a) combining (i) the formulation comprising a propylene-based elastomer, said propylene-based elastomer comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (ii) a polyalphaolefin, and (b) forming a composition; wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

Other embodiments can include:

1. A composition comprising:
(a) a propylene-based elastomer, comprising at least about 60 wt % propylene-derived units and about 5 to about 25 wt % ethylene-derived units, based on total weight of the propylene-based elastomer, wherein the propylene-based elastomer has a heat of fusion of less than about 80 J/g; and
(b) a polyalphaolefin;

wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

2. The composition of paragraph 1, wherein the propylene-based elastomer is present in an amount of about 2 to about 98 wt % of the composition.
3. The composition of paragraph 1 or 2, wherein the propylene-based elastomer is present in an amount of about 2 to about 60 wt % of the composition.
4. The composition of any of paragraphs 1-3, wherein the polyalphaolefin is present in an amount of about 2 to about 98 wt % of the composition.
5. The composition of any of paragraphs 1-4, wherein the polyalphaolefin is present in an amount of about 2 to about 60 wt % of the composition.
6. The composition of any of paragraphs 1-5, wherein the polyalphaolefin is present in an amount of about 2 to about 30 wt % of the composition.
7. The composition of any of paragraphs 1-6, further comprising a thermoplastic polyolefin.
8. The composition of paragraph 7, wherein the thermoplastic polyolefin is present in an amount of about 1 to about 5 wt % of the composition.
9. The composition of paragraph 7 or 8, wherein the thermoplastic polyolefin is polypropylene.
10. The composition of any of paragraphs 1-9, further comprising a filler.
11. The composition of paragraph 10, wherein the filler is present in an amount of about 20 to about 90 wt % of the composition.
12. The composition of paragraph 10 or 11, wherein the filler is at least one of calcium carbonate, antimony oxide, barium sulfate, fly ash, and carbon black.
13. The composition of any of paragraphs 1-12, wherein the composition has the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).
14. The composition of any of paragraphs 1-13, wherein the composition has at least one of the following properties: (a) a 100% modulus above about 140 psi (ASTM D412); (b) a tensile strength above about 500 psi (ASTM D412); (c) a tear resistance above about 15 kN/m (ASTM D624); (d) an elongation at break above about 950% (ASTM D412); and (e) a specific gravity above about 1.0 g/cc (ASTM D792).
15. A method for preparing a composition, comprising the steps of:
(a) combining (i) a propylene-based elastomer comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (ii) a polyalphaolefin, and
(b) forming the composition;

wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

16. The method of paragraph 15, further comprising the step of forming the composition into an article.
17. An article comprising the composition of any of paragraphs 1-14.
18. The article of paragraph 17, wherein the article is selected for vehicle uses from the group consisting of bumper, bumper fascia; exterior body panel, door panel, grill, exterior trim, body side molding, side cladding, side molding, end cap, hood, deck lid, mirror housing, roof rack, wheel cover, wheel liner, wheel flare, fender liner, hub cap, running board, step pad, sill plate, air dam, splash shield, mud guard, bed liner, and rocker panel; fuel tank; interior trim, including steering column cover, console, door panel, pillar, support, knob, button, handle, safety screen, instrument panel, dash board, knee bolster; passenger side airbag cover, headliner, glove box, tray, cup holder, compartment, lid, seat component, back, support, safety belt securing device, under-hood part, battery tray, fan shroud, electrical housing; cable bearing, structural component, door carrier, truck bed separator, load floor, and trunk divider.
19. The article of paragraph 17, wherein the article is selected for non-vehicle uses from the group consisting of film, tape, sheet, fiber, tubing, pipe, coating, fabric (woven and nonwoven), tarp, agricultural barrier, packaging (durable and disposable), household appliance, washing machine, refrigerator, blender, air conditioner, furniture (indoor and outdoor), table, chair, bench, shelving, sporting equipment, ski, surfboard, skateboard, skate, boot, sled, scooter, kayak, paddle, solid wheel, stadium seating, amusement park ride, personal protective equipment, safety helmet, shin guard, emergency response equipment, cookware, utensil, tray, pallet, cart, tank, tub, pond liner, storage container, crate, pail, jar, bottle, toy, child car seat and booster chair, medical device, sportswear, luggage, tool housing, electronics housing, building construction material, flooring, siding, roofing, counter top, electrical housing and connector, lighting, gardening equipment, handle on shovel, handle on wheelbarrow, playground equipment, motor housing, pump housing, battery housing, instrument housing, switch, knob, button, handle, pet supply, laboratory supply, personal hygiene device, razor, brush, hairdryer, cleaning supply, broom, dust pan, musical instrument case, statue, trophy, artwork, costume jewelry, picture frame, eyeglass frame, plant pot, and firearm component.
20. A vehicle comprising the composition of any of paragraphs 1-14, wherein the vehicle is selected from the group consisting of car, truck, bus, boat, all terrain vehicle, personal water craft, golf cart, snowmobile, motorcycle, moped, tractor, mower, wagon, bicycle, airplane, helicopter, train, military machine, and gondola car.
21. A composition comprising:
(a) about 17 to about 42 wt % of a propylene-based elastomer, said propylene-based elastomer comprising at least about 60 wt % propylene-derived units and about 5 to about 25 wt % ethylene-derived units based on total weight of the propylene-based elastomer, wherein the propylene-based elastomer has a heat of fusion of less than about 80 J/g;
(b) about 5 to about 20 wt % of a polyalphaolefin;
(c) about 3 wt % of a homopolypropylene; and
(d) about 50 to about 60 wt % of calcium carbonate;

each based on the total weight of the composition.

22. A method for lowering the glass transition temperature of a formulation comprising a propylene-based elastomer, said method comprising the steps of:
(a) combining (i) the formulation comprising a propylene-based elastomer, said propylene-based elastomer comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (ii) a polyalphaolefin, and
(b) forming a composition;

wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

### EXAMPLES

The present invention, while not meant to be limited by, may be better understood by reference to the following example and tables. The examples show the effects of a polyalphaolefin on properties of the inventive composition in comparison with a composition without the polyalphaolefin but otherwise identical in terms of its constituents by Samples 1-16. For comparative purposes, a comparative example (“Control”) is provided to illustrate the corresponding properties of a composition without a polyalphaolefin.

Each sample was prepared in a 53 mm twin screw mixer, operated at 350 RPM under a barrel temperature of 150° C. to 170° C., with an output of 40 kg/hr. Some other processing parameters were set as follows in Table 1.

TABLE 1
Key Processing Parameters

| Parameters | Values |
|---|---|
| Barrel Cooling H₂O | 35° C. |
| Temperature | |
| Melt Pump Suction Pressure | 500 psi [AUTO] |
| Pelletizer Water Temperature | 40° C.-50° C. |
| Pelletizer Water Flowrate | As needed |
| Die Hole Open | 4 |
| Cutter Spindle | 6 blade |
| Pelletizer Speed | ~700 RPM-1500 RPM, adjusted as needed |

Samples 1-16 contains Vistamaxx™ 6102 propylene-based elastomer, Spectrasyn™ 10 polyalphaolefin, Hubercarb M4 calcium carbonate and hPP 5341 homopolypropylene at varying proportions as listed below, together with the Control, in Table 2. Typical physical properties including hardness, 100% modulus, tensile strength, tear resistance, elongation at break and specific gravity are demonstrated as measured in Table 3. Data for glass transition temperature and impact mode are shown in Tables 4 and 5, respectively.

It can be seen from the following tables that by addition of a polyalphaolefin, a composition comprising a propylene-based elastomer achieved a reduced hardness of about 25 to about 67 shore A and an improved glass transition temperature ranging from about −35° C. to about −65° C., compared with a composition in which the polyalphaolefin was absent. As the glass transition temperature was substantially lowered, the propylene-based elastomer then functioned as an impact modifier at a temperature as low as −40° C., thus, enabling the inventive composition to obtain impact resistance. Meanwhile, the composition maintained good physical properties without great loss in, e.g., 100% modulus, tensile strength, tear resistance, elongation at break and specific gravity. Moreover, the filler loading level could be increased, such as to 75 wt %, or up to 90 wt % of the composition, which may satisfy economical uses where needed in a cost effective way.

All documents described herein are incorporated by reference herein, including any priority documents and/or testing procedures. When numerical lower limits and numerical upper limits are listed herein, ranges from any lower limit to any upper limit are contemplated. As is apparent from the foregoing general description and the specific embodiments, while forms of the invention have been illustrated and described, various modifications can be made without departing from the spirit and scope of the invention. Accordingly, it is not intended that the invention be limited thereby.

TABLE 2
Formulation (wt %) of Samples 1-16 and Control

| Sample No. | 1 | 2 | 3 | 4 | 5 | 6 | 7 | 8 | 9 |
|---|---|---|---|---|---|---|---|---|---|
| Vistamaxx 6202 | 57.00 | 47.00 | 37.00 | 27.00 | 42.00 | 37.00 | 32.00 | 27.00 | 32.00 |
| HuberCarb M4 | 20.00 | 30.00 | 30.00 | 40.00 | 50.00 | 50.00 | 50.00 | 50.00 | 60.00 |
| Spectrasyn 10 | 20.00 | 20.00 | 30.00 | 30.00 | 5.00 | 10.00 | 15.00 | 20.00 | 5.00 |
| hPP 5341 | 3.00 | 3.00 | 3.00 | 3.00 | 3.00 | 3.00 | 3.00 | 3.00 | 3.00 |
| Total | 100.00 | 100.00 | 100.00 | 100.00 | 100.00 | 100.00 | 100.00 | 100.00 | 100.00 |

| Sample No. | 10 | 11 | 12 | 13 | 14 | 15 | 16 | Control |
|---|---|---|---|---|---|---|---|---|
| Vistamaxx 6202 | 27.00 | 22.00 | 17.00 | 17.00 | 12.00 | 7.00 | 2.00 | 57.00 |
| HuberCarb M4 | 60.00 | 60.00 | 60.00 | 75.00 | 75.00 | 75.00 | 75.00 | 40.00 |
| Spectrasyn 10 | 10.00 | 15.00 | 20.00 | 5.00 | 10.00 | 15.00 | 20.00 | 0.00 |
| hPP 5341 | 3.00 | 3.00 | 3.00 | 3.00 | 3.00 | 3.00 | 3.00 | 3.00 |
| Total | 100.00 | 100.00 | 100.00 | 100.00 | 100.00 | 100.00 | 100.00 | 100.00 |

TABLE 3
Typical Physical Properties of Samples 1-16 and Control

| Physical | Sample No. | | | | | | | | |
|---|---|---|---|---|---|---|---|---|---|
| Properties, Unaged | 1 | 2 | 3 | 4 | 5 | 6 | 7 | 8 | 9 |
| Hardness, Shore A (15 sec) | 50.5 | 47.8 | 33.8 | 25.7 | 66.8 | 54.5 | 46.8 | 42.3 | 74.3 |
| 100% Modulus, psi | 153 | 142 | 82 | 68 | 269 | 196 | 156 | 114 | 257 |
| Tens. Strength, psi | 614 | 543 | 209 | 102 | 542 | 245 | 166 | 119 | 451 |
| Tear Resistance Die “C”, kN/m | 17.6 | 15.8 | 8.7 | 6.3 | 24.7 | 18.0 | 13.6 | 8.7 | 22.2 |
| Ult. Elongation, % | 938 | 969 | 951 | 604 | 931 | 474 | 302 | 171 | 907 |
| Specific Gravity, g/cc | 0.9978 | 1.0727 | 1.0746 | 1.1701 | 1.3052 | 1.2869 | 1.2875 | 1.3036 | 1.4545 |

| Physical | Sample No. | | | | | | | |
|---|---|---|---|---|---|---|---|---|
| Properties, Unaged | 10 | 11 | 12 | 13 | 14 | 15 | 16 | Control |
| Hardness, Shore A (15 sec) | 56.2 | 46.3 | 38.8 | 78.6 | 89.4 | 71.4 | 50.4 | 73.1 |
| 100% Modulus, psi | 185 | 127 | 99 | 0 | 0 | 0 | 0 | 316 |
| Tens. Strength, psi | 198 | 132 | 99 | 0 | 0 | 0 | 0 | 1310 |
| Tear Resistance Die “C”, kN/m | 15.2 | 9.7 | 6.3 | 16.8 | 7.7 | 2.9 | n/a | 41 |
| Ult. Elongation, % | 53 | 67 | 72 | 0 | 0 | 0 | 0 | 895 |
| Specific Gravity, g/cc | 1.4358 | 1.4271 | 1.4756 | 1.7604 | 1.7504 | 1.7656 | 1.6809 | 1.1832 |

TABLE 4
Glass Transition Temperature of Samples 1-16 and Control

| Sample No. | 1 | 2 | 3 | 4 | 5 | 6 | 7 | 8 | 9 |
|---|---|---|---|---|---|---|---|---|---|
| 1st Heat/ | | | | | | | | | |
| Cool at 10° C./min | | | | | | | | | |
| Infl. T_{g} (° C.) | −46.14 | −49.95 | −60.06 | −65.51 | −36.24 | −43.13 | −46.74 | −54.34 | −37.10 |
| Tₘ₁ (° C.) | 47.83 | 46.79 | 42.27 | 40.78 | 50.40 | 50.67 | 51.17 | 51.90 | 50.66 |
| ΔH_{f1} (J/g) | 0.29 | 0.28 | 0.14 | 0.22 | 2.44 | 1.41 | 1.07 | 0.74 | 1.56 |
| Tₘ₂ (° C.) | 94.51 | 157.95 | 155.90 | 154.08 | 161.56 | 159.85 | 158.85 | 157.10 | 161.09 |
| ΔH_{f2} (J/g) | 0.30 | 1.31 | 2.06 | 2.38 | 1.71 | 1.59 | 1.97 | 3.88 | 2.29 |
| T_{c1} (° C.) | 70.57 | 73.95 | 80.99 | 93.71 | 91.11 | 92.15 | 95.71 | 97.46 | 80.57 |
| ΔH_{c1} (J/g) | 6.81 | 6.16 | 5.65 | 5.52 | 4.09 | 4.29 | 3.82 | 5.18 | 3.21 |
| 2nd Heat/ | | | | | | | | | |
| Cool at 10° C./min | | | | | | | | | |
| Infl. T_{g} (° C.) | −47.17 | −50.28 | −60.20 | −64.83 | −36.15 | −42.46 | −46.36 | −55.68 | −37.32 |
| Tₘ₁ (° C.) | 157.39 | 157.75 | 154.69 | 153.13 | 160.55 | 159.28 | 157.71 | 155.70 | 160.15 |
| ΔH_{f1} (J/g) | 1.56 | 1.96 | 2.48 | 2.08 | 2.03 | 4.04 | 2.00 | 2.26 | 2.39 |
| T_{c1} (° C.) | 71.97 | 77.98 | 84.54 | 94.86 | 89.70 | 93.53 | 95.80 | 95.51 | 80.19 |
| ΔH_{c1} (J/g) | 6.99 | 5.56 | 5.51 | 5.91 | 4.22 | 5.62 | 4.20 | 4.93 | 3.82 |

| Sample No. | 10 | 11 | 12 | 13 | 14 | 15 | 16 | control |
|---|---|---|---|---|---|---|---|---|
| 1st Heat/ | | | | | | | | |
| Cool at 10° C./min | | | | | | | | |
| Infl. T_{g} (° C.) | −44.68 | −54.95 | −66.42 | −43.33 | — | — | — | −31.28 |
| Tₘ₁ (° C.) | 49.10 | 51.25 | 47.19 | 49.30 | 51.87 | 50.55 | — | 46.15 |
| ΔH_{f1} (J/g) | 0.51 | 0.30 | 0.02 | 0.33 | 0.26 | 0.11 | — | 3.26 |
| Tₘ₂ (° C.) | 159.08 | 156.60 | 154.66 | 159.68 | 156.78 | 153.40 | 146.23 | 161.84 |
| ΔH_{f2} (J/g) | 2.41 | 2.88 | 3.03 | 2.41 | 2.75 | 2.91 | 4.81 | 1.27 |
| T_{c1} (° C.) | 83.29 | 88.02 | 95.50 | 91.92 | 93.64 | 91.78 | 92.17 | 69.24 |
| ΔH_{c1} (J/g) | 3.25 | 2.30 | 4.65 | 3.24 | 3.20 | 2.77 | 3.17 | 4.22 |
| 2nd Heat/ | | | | | | | | |
| Cool at 10° C./min | | | | | | | | |
| Infl. T_{g} (° C.) | −45.63 | −54.14 | −63.66 | −42.30 | — | — | — | −31.65 |
| Tₘ₁ (° C.) | 158.24 | 156.03 | 154.05 | 159.01 | 155.42 | 152.39 | 146.84 | 161.18 |
| ΔH_{f1} (J/g) | 2.13 | 2.74 | 2.05 | 1.92 | 2.42 | 2.54 | 2.67 | 2.23 |
| T_{c1} (° C.) | 82.57 | 57.07 | 94.09 | 90.74 | 92.75 | 90.77 | 90.85 | 75.57 |
| ΔH_{c1} (J/g) | 3.34 | 3.42 | 4.53 | 3.11 | 3.09 | 2.51 | 2.67 | 4.77 |

Note:
T_{g}—glass transition temperature; Tₘ—melting temperature; T_{c}—crystallization temperature; ΔH_{f}—heat of fusion; ΔH_{c}—heat of crystallization.

TABLE 5
Impact Mode at −40° C. of Samples 1-16 and Control

| Sample No. | 1 | 2 | 3 | 4 | 5 | 6 | 7 | 8 | 9 | 10 | 11 | 12 | 13 | 14 | 15 | 16 | control |
|---|---|---|---|---|---|---|---|---|---|---|---|---|---|---|---|---|---|
| Instrumented Impact at −40° C. | 9.4 | 5.5 | 5.9 | 3.8 | 10.4 | 2.3 | 2.5 | 5.2 | 4.0 | 2.6 | 4.7 | 2.4 | 0.8 | 0.2 | 1.2 | ND | 2.3 |
| Energy to Max Load, 2.2 | | | | | | | | | | | | | | | | | |
| m/sec on | | | | | | | | | | | | | | | | | |
| Impact Mode | D | D | D | D | DB | DB | DB | D | DB | DB | DB | DB | B | B | DB | ND | B |

Note:
D—ductile (very good); DB—ductile brittle (pass); B—brittle (fail); ND—no data.

What is claimed is:

1. A composition comprising:
(a) a propylene-based elastomer, comprising at least about 60 wt % propylene-derived units and about 5 to about 25 wt % ethylene-derived units, based on total weight of the propylene-based elastomer, wherein the propylene-based elastomer has a heat of fusion of less than about 80 J/g; and
(b) a polyalphaolefin;
wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

2. The composition of claim 1, wherein the propylene-based elastomer is present in an amount of about 2 to about 98 wt % of the composition.

3. The composition of claim 1, wherein the propylene-based elastomer is present in an amount of about 2 to about 60 wt % of the composition.

4. The composition of claim 1, wherein the polyalphaolefin is present in an amount of about 2 to about 98 wt % of the composition.

5. The composition of claim 1, wherein the polyalphaolefin is present in an amount of about 2 to about 60 wt % of the composition.

6. The composition of claim 1, wherein the polyalphaolefin is present in an amount of about 2 to about 30 wt % of the composition.

7. The composition of claim 1, further comprising a thermoplastic polyolefin.

8. The composition of claim 7, wherein the thermoplastic polyolefin is present in an amount of about 1 to about 5 wt % of the composition.

9. The composition of claim 7, wherein the thermoplastic polyolefin is polypropylene.

10. The composition of claim 1, further comprising a filler.

11. The composition of claim 10, wherein the filler is present in an amount of about 20 to about 90 wt % of the composition.

12. The composition of claim 10, wherein the filler is at least one of calcium carbonate, antimony oxide, barium sulfate, fly ash, and carbon black.

13. The composition of claim 1, wherein the composition has the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

14. The composition of claim 1, wherein the composition has at least one of the following properties: (a) a 100% modulus above about 140 psi (ASTM D412); (b) a tensile strength above about 500 psi (ASTM D412); (c) a tear resistance above about 15 kN/m (ASTM D624); (d) an elongation at break above about 950% (ASTM D412); and (e) a specific gravity above about 1.0 g/cc (ASTM D792).

15. A method for preparing a composition, comprising the steps of:
(a) combining (i) a propylene-based elastomer comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (ii) a polyalphaolefin, and
(b) forming the composition;
wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).

16. The method of claim 15, further comprising the step of forming the composition into an article.

17. An article comprising the composition of claim 1.

18. The article of claim 17, wherein the article is selected for vehicle uses from the group consisting of bumper, bumper fascia; exterior body panel, door panel, grill, exterior trim, body side molding, side cladding, side molding, end cap, hood, deck lid, mirror housing, roof rack, wheel cover, wheel liner, wheel flare, fender liner, hub cap, running board, step pad, sill plate, air dam, splash shield, mud guard, bed liner, and rocker panel; fuel tank; interior trim, including steering column cover, console, door panel, pillar, support, knob, button, handle, safety screen, instrument panel, dash board, knee bolster; passenger side airbag cover, headliner, glove box, tray, cup holder, compartment, lid, seat component, back, support, safety belt securing device, under-hood part, battery tray, fan shroud, electrical housing; cable bearing, structural component, door carrier, truck bed separator, load floor, and trunk divider.

19. The article of claim 17, wherein the article is selected for non-vehicle uses from the group consisting of film, tape, sheet, fiber, tubing, pipe, coating, fabric (woven and nonwoven), tarp, agricultural barrier, packaging (durable and disposable), household appliance, washing machine, refrigerator, blender, air conditioner, furniture (indoor and outdoor), table, chair, bench, shelving, sporting equipment, ski, surfboard, skateboard, skate, boot, sled, scooter, kayak, paddle, solid wheel, stadium seating, amusement park ride, personal protective equipment, safety helmet, shin guard, emergency response equipment, cookware, utensil, tray, pallet, cart, tank, tub, pond liner, storage container, crate, pail, jar, bottle, toy, child car seat and booster chair, medical device, sportswear, luggage, tool housing, electronics housing, building construction material, flooring, siding, roofing, counter top, electrical housing and connector, lighting, gardening equipment, handle on shovel, handles on wheelbarrow, playground equipment, motor housing, pump housing, battery housing, instrument housing, switch, knob, button, handle, pet supply, laboratory supply, personal hygiene device, razor, brush, hairdryer, cleaning supply, broom, dust pan, musical instrument case, statue, trophy, artwork, costume jewelry, picture frame, eyeglass frame, plant pot, and firearm component.

20. A vehicle comprising the composition of claim 1, wherein the vehicle is selected from the group consisting of car, truck, bus, boat, all-terrain vehicle, personal water craft, golf cart, snowmobile, motorcycle, moped, tractor, mower, wagon, bicycle, airplane, helicopter, train, military machine, and gondola car.

21. A composition comprising:
(a) about 17 to about 42 wt % of a propylene-based elastomer, said propylene-based elastomer comprising at least about 60 wt % propylene-derived units and about 5 to about 25 wt % ethylene-derived units based on total weight of the propylene-based elastomer, wherein the propylene-based elastomer has a heat of fusion of less than about 80 J/g;
(b) about 5 to about 20 wt % of a polyalphaolefin;
(c) about 3 wt % of a homopolypropylene; and
(d) about 50 to about 60 wt % of calcium carbonate;
each based on the total weight of the composition.

22. A method for lowering the glass transition temperature of a formulation comprising a propylene-based elastomer, said method comprising the steps of:
(a) combining (i) the formulation comprising a propylene-based elastomer, said propylene-based elastomer comprising at least about 60 wt % propylene-derived units and about 5 to about 25 wt % ethylene-derived units, based on total weight of the propylene-based elastomer, wherein the propylene-based elastomer has a heat of fusion of less than about 80 J/g, and (ii) a polyalphaolefin, and
(b) forming a composition;
wherein the composition has at least one of the following properties: (a) a hardness of about 25 to about 67 shore A (ASTM D2240); (b) a glass transition temperature of about −35° C. to about −65° C. (ASTM D3418-08, 10° C./min); and (c) an impact resistance at a temperature no lower than about −40° C. (ASTM D3763).
